(19) United States
(12) Patent Application Publication
(10) Pub. No.: US 2024/0405475 A1
(43) Pub. Date: Dec. 5, 2024

(54) ELECTRICAL CONNECTOR

(71) Applicant: MOLEX, LLC, Lisle, IL (US)

(72) Inventor: Teng Fei Zhang, Shanghai (CN)

(21) Appl. No.: 18/676,526

(22) Filed: May 29, 2024

(30) Foreign Application Priority Data
May 29, 2023 (CN) 202310619842.4

(51) Int. Cl. H01R 13/518; H01R 13/04; H01R 13/506

(52) U.S. Cl. CPC H01R 13/518; H01R 13/04; H01R 13/506

(57) ABSTRACT

An electrical connector is provided to include a shielding shell assembly, a conductive pin and an insulative housing. The conductive pin is positioned in the shielding shell assembly, the conductive pin includes a first end and a second end which are perpendicular to each other, the insulative housing allows the conductive pin to be fixed thereon and separates the shielding shell assembly from the conductive pin; the shielding shell assembly includes a middle shielding shell, a first shielding shell and a second shielding shell. The first shielding shell is provided to one side of the middle shielding shell and extends along a horizontal direction, the second shielding shell is provided to a bottom of the middle shielding shell and extends downwardly, the first shielding shell surrounds an outer side of the first end of the conductive pin to form a first mating cavity, the second shielding shell surrounds an outer side of the second end of the conductive pin to form a second mating cavity. The first shielding shell and the second shielding shell constitute two mating cavities of the electrical connector which are perpendicular to each other, thereby realizing that the electrical connector mates with two electrical connectors along different directions.

### RELATED APPLICATION

The present application claims priority to Chinese patent application no. 202310619842.4 filed on May 29, 2023, which is incorporated by reference in its entirety.

### TECHNICAL FIELD

The present disclosure relates to the technical field of connectors, and particularly relates to an electrical connector.

### BACKGROUND

Chinese patent application CN115332854A discloses a FAKRA connector, the FAKRA connector has a central axis which extends front and rear, and includes an outer casing and a contact unit, the outer casing is provided therein with a contact member mounting cavity which is used to mount the contact unit, a central axis of the contact member mounting cavity is coincide with the central axis of the FAKRA connector or is parallel to the central axis of the FAKRA connector and is distributed around the central axis of the FAKRA connector, the outer casing includes a front casing which is used to connect a connector which is adapted to mate with the FAKRA connector and a rear casing which is used to be mounted on a board, the contact member mounting cavity is constituted by a front hole which is provided to the front casing and a rear hole which is provided to the rear casing mate with each other, a rear portion of the front casing is provided with a front mating structure, a front portion of the rear casing is provided with a rear mating structure which is adapted to mate with the front mating structure; the rear mating structure is provided thereon with an upper position-limiting protrusion and a lower position-limiting protrusion which are distributed up and down relative to the central axis of the FAKRA connector and protrude perpendicularly to the central axis of the FAKRA connector, two engaging locations where the front mating structure and the rear mating structure mate with each other up and down are respectively provided with two position-limiting structures which are used to clamp the rear mating structure therebetween, that is, an upper position-limiting protrusion cooperating structure which interference fits with the upper position-limiting protrusion and a lower position-limiting protrusion cooperating structure which interference fits the lower position-limiting protrusion, so that the rear casing is capable of being guided to be right by the upper position-limiting protrusion and the lower position-limiting protrusion with respect to the front casing 1 relative to the central axis of the FAKRA connector, so as to assure coaxiality of the front hole and the rear hole along the central axis of the FAKRA connector.

However, in this technical solution, the front casing is adapted to mate with a cable connector, the rear casing is adapted to be mounted on a circuit board, so such a connector is mounted on the circuit board and is used to connect a cable connector, but cannot satisfy two electrical connectors to mate therewith along different directions.

### SUMMARY

A technical problem solved by the present disclosure is to provide an electrical connector which can satisfy two electrical connectors to mate therewith along different directions so as to overcome the deficiency existing in the prior art.

In order to solve the above technical problem, the present disclosure provides an electrical connector, comprising: a shielding shell assembly, a conductive pin which is positioned in the shielding shell assembly, the conductive pin comprises a first end and a second end which are perpendicular to each other, and an insulative housing which allows the conductive pin to be fixed thereon and separates the shielding shell assembly from the conductive pin; the shielding shell assembly comprises: a middle shielding shell, a first shielding shell which is provided to one side of the middle shielding shell and extends along a horizontal direction, and a second shielding shell which is provided to a bottom of the middle shielding shell and extends downwardly, the first shielding shell surrounds an outer side of the first end of the conductive pin to form a first mating cavity, the second shielding shell surrounds an outer side of the second end of the conductive pin to form a second mating cavity.

In an embodiment, the second shielding shell comprises an upper shell which is connected with the middle shielding shell and a lower shell which is provided below the upper shell, the upper shell comprises a first main body which is provided therein with a passageway and a first fixing flange which is provided to a lower end of the first main body and extends horizontally, the lower shell comprises a second main body which is provided therein with a passageway and a second fixing flange which is provided to an upper end of the second main body and extends horizontally, the first fixing flange and the second fixing flange attach to each other and are fixed together.

In an embodiment, the electrical connector further comprises an insulative base which is provided to an outer side of the shielding shell assembly and a metal seat body which is fixed to a bottom of the insulative base, the metal seat body is opened therein with an opened hole which penetrates up and down, the lower shell downwardly extends out of the metal seat body via the opened hole.

In an embodiment, the metal seat body is provided with a mating post around the opened hole, the bottom of the insulative base is provided with a protruding flange, the protruding flange inserts into the mating post, a top portion of the mating post is provided with a folding edge, the folding edge hooks on the protruding flange.

In an embodiment, a bottom of the protruding flange is provided with a mating base portion, the mating post sheathes an outer side of the mating base portion, the mating post and the mating base portion are provided therebetween with a first sealing ring, a bottom of the mating post is encircled with a recessed groove which is opened downwardly, the recessed groove is provided therein with a second sealing ring.

In an embodiment, a surface of the middle shielding shell is provided with an clastic snap which protrudes outwardly and/or a latching piece which is recessed inwardly, the clastic snap snaps with the insulative base or the latching pieces latches the insulative base.

In an embodiment, the first shielding shell comprises a barrel-shaped body and a connecting portion which is provided to one end of the barrel-shaped body, one side of the middle shielding shell is provided with a first opening, and an edge of the first opening is provided with a folding edge which extends toward a center of the first opening, the connecting portion is fixed on the folding edge.

In an embodiment, the bottom of the middle shielding shell is provided with a second opening, a bottom of the insulative housing is provided with an assembling cavity which faces the second opening, an upper end of the second shielding shell inserts into the assembling cavity and tightly fits with an inner wall of the assembling cavity.

In an embodiment, the middle shielding shell is provided with at least one connecting arm which is positioned at an edge of the second opening and extends downwardly, the connecting arm elastically contacts an outer surface of the second shielding shell, or the second shielding shell is fixedly connected with the connecting arm.

In an embodiment, the middle shielding shell is a box structure which is formed by bending a metal plate, the box structure is formed therein with a receiving cavity, at least a part of the insulative housing is received in the receiving cavity.

In comparison with the prior art, the present disclosure at least has following advantages: the electrical connector of the present disclosure comprises a shielding shell assembly, a conductive pin and an insulative housing, the conductive pin comprises a first end and a second end which are perpendicular to each other, the shielding shell assembly comprises a middle shielding shell, a first shielding shell and a second shielding shell, the first shielding shell surrounds an outer side of the first end of the conductive pin to form a first mating cavity, the second shielding shell surrounds an outer side of the second end of conductive pin to form a second mating cavity, the first shielding shell and the second shielding shell constitute two mating cavities of the electrical connector which are perpendicular to each other, thereby realizing that the electrical connector mates with two electrical connectors along different directions. And the electrical connector is lower in manufacturing cost, and is convenient in assembling.

### BRIEF DESCRIPTION OF THE DRAWINGS

FIG. 1 is a perspective view of an electrical connector of a first embodiment of the present disclosure.

FIG. 2 is a perspective view of the electrical connector of the first embodiment of the present disclosure viewed from another angle.

FIG. 3 is a front view of the electrical connector of the first embodiment of the present disclosure.

FIG. 4 is a cross sectional view taken along A-A line of FIG. 3.

FIG. 5 is a perspective view of a shielding shell assembly, a conductive pin and an insulative housing of the electrical connector of the first embodiment of the present disclosure.

FIG. 6 is a perspective view of FIG. 5 viewed from another angle.

FIG. 7 is a side view of FIG. 5.

FIG. 8 is a bottom view of FIG. 5.

FIG. 9 is a cross sectional view taken along B-B line of FIG. 8.

FIG. 10 is a perspective exploded view of the shielding shell assembly, the conductive pin and the insulative housing of the electrical connector of the first embodiment of the present disclosure.

FIG. 11 is a perspective exploded view of FIG. 10 viewed from another angle.

FIG. 12 is a perspective exploded view further exploded on a basis of FIG. 10.

FIG. 13 is a perspective exploded view of FIG. 12 viewed from another angle.

FIG. 14 is a perspective view of an electrical connector of a second embodiment of the present disclosure.

FIG. 15 is a perspective view of the electrical connector of the second embodiment of the present disclosure viewed from another angle.

FIG. 16 is a front view of the electrical connector of the second embodiment of the present disclosure.

FIG. 17 is a bottom view of the electrical connector of the second embodiment of the present disclosure.

FIG. 18 is a side view of the electrical connector of the second embodiment of the present disclosure.

FIG. 19 is a cross sectional view taken along C-C line of FIG. 18.

FIG. 20 is a perspective exploded view of the electrical connector of the second embodiment of the present disclosure.

FIG. 21 is a perspective exploded view of the electrical connector of the second embodiment of the present disclosure viewed from another angle.

FIG. 22 is a perspective exploded view of the electrical connector of the second embodiment of the present disclosure which is further exploded.

FIG. 23 is a perspective exploded view of FIG. 22 viewed from another angle.

FIG. 24 is a perspective exploded view of FIG. 22 viewed from still another angle.

FIG. 25 is a perspective exploded view of a shielding shell assembly, a conductive pin and an insulative housing of the electrical connector of the second embodiment of the present disclosure.

FIG. 26 is a perspective exploded view of FIG. 25 viewed from another angle.

FIG. 27 is a perspective exploded view further exploded on a basis of FIG. 25.

FIG. 28 is a perspective exploded view further exploded on a basis of FIG. 26.

FIG. 29 is a perspective exploded view further exploded on a basis of FIG. 28.

### DETAILED DESCRIPTION

While the present disclosure may be susceptible to embodiments in different forms, there are shown in the figures, and will be described herein in detail, are only specific embodiments, with the understanding that the present disclosure is to be considered as an exemplification of the principles of the present disclosure, and is not intended to limit the present disclosure to that as illustrated.

Hence references to a feature are intended to describe a feature of an embodiment of the present disclosure, not to imply that every embodiment thereof must have the described feature. Furthermore, it should be noted that the description illustrates a number of features. While certain features have been combined together to illustrate potential system designs, those features may also be used in other combinations not expressly disclosed. Thus, the depicted combinations are not intended to be limiting, unless otherwise noted.

In the embodiments illustrated in the figures, representations of directions such as up, down, left, right, front and rear, used for explaining the structure and movement of the various parts of the present disclosure, are not absolute, but relative. These representations are appropriate when the parts are in the position shown in the figures. If the description of the position of the parts changes, however, these representations are to be changed accordingly.

Hereinafter, embodiments of the present disclosure will be further described in detail in combination with the figures. The following embodiments and features in the embodiments may be combined with each other without confliction.

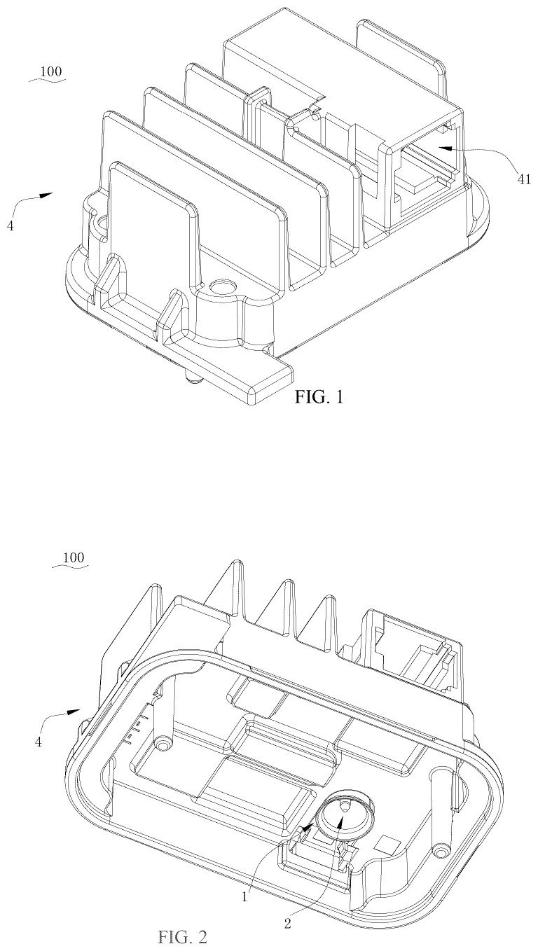

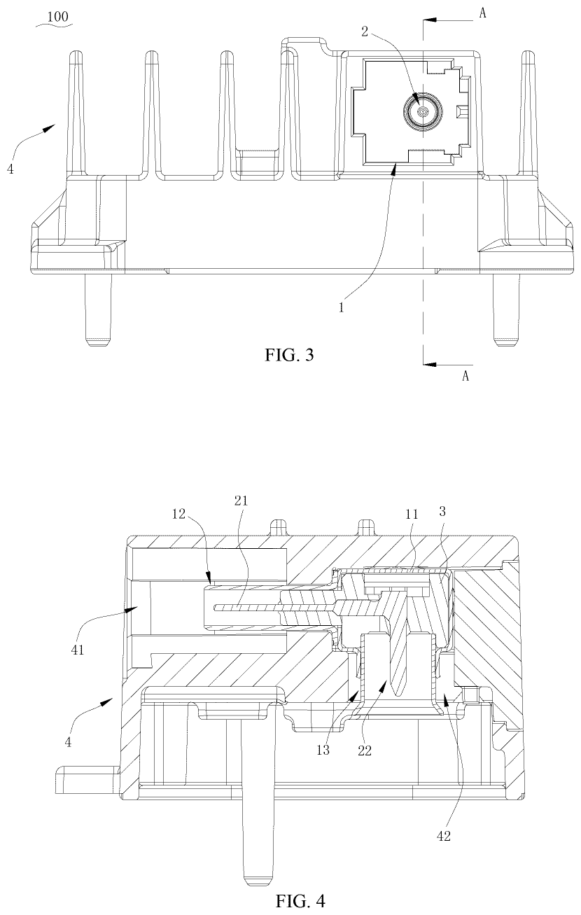

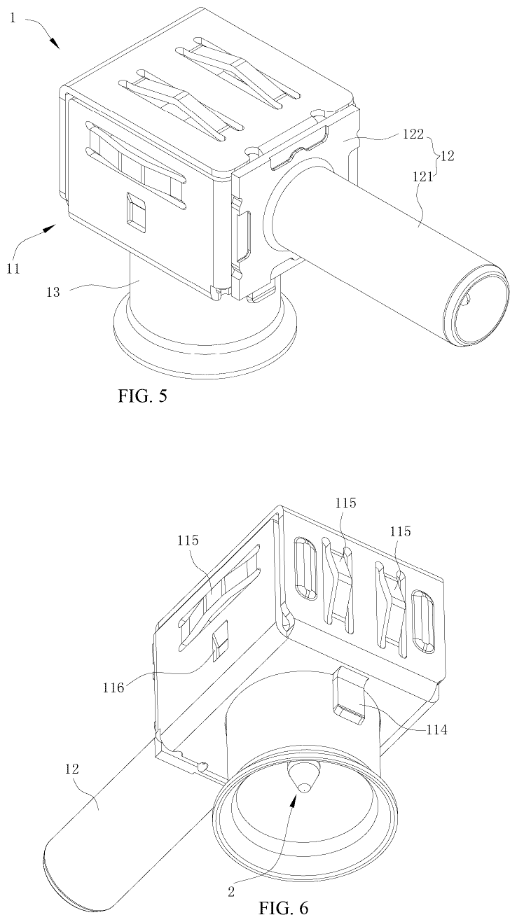

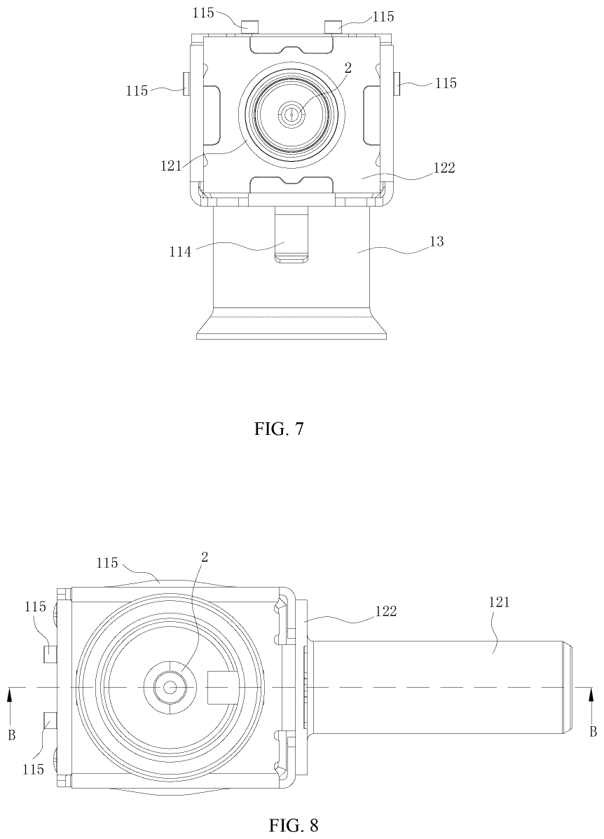

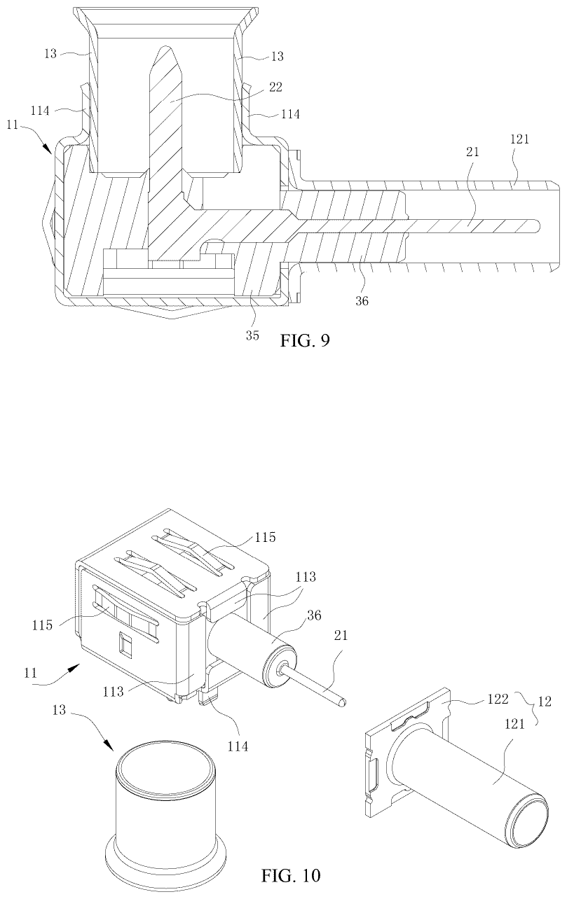

Firstly referring to FIG. 1 to FIG. 9, an electrical connector 100 of the first embodiment includes a shielding shell assembly 1, a conductive pin 2 which is positioned in the shielding shell assembly 1, and an insulative housing 3 which allows the conductive pin 2 to be fixed thereon and separates the shielding shell assembly 1 from the conductive pin 2 by a certain distance. Here, the conductive pin 2 is in form of L-shape, and includes a first end 21 and a second end 22 which are perpendicular to each other. The shielding shell assembly 1 includes a middle shielding shell 11, a first shielding shell 12 which is provided to one side of the middle shielding shell 11 and extends along a horizontal direction, and the second shielding shell 13 which is provided to a bottom of the middle shielding shell 11 and extends downwardly. Here, the first shielding shell 12 surrounds an outer side of the first end 21 of the conductive pin 2 to form a first mating cavity, the second shielding shell 13 surrounds an outer side of the second end 22 of the conductive pin 2 to form a second mating cavity. The first mating cavity and the second mating cavity constitute two mating cavities of the electrical connector 100 which are perpendicular to each other, thereby realizing that the electrical connector 100 mates with two electrical connectors along different directions.

For sake of description, in the electrical connector 100, a direction that the middle shielding shell 11 is toward the first shielding shell 12 is defined as front, a direction that the middle shielding shell 11 is away from the first shielding shell 12 is defined as rear, a direction that the middle shielding shell 11 is toward the second shielding shell 13 is defined as down, a direction that the middle shielding shell 11 is away from the second shielding shell 13 is defined as up.

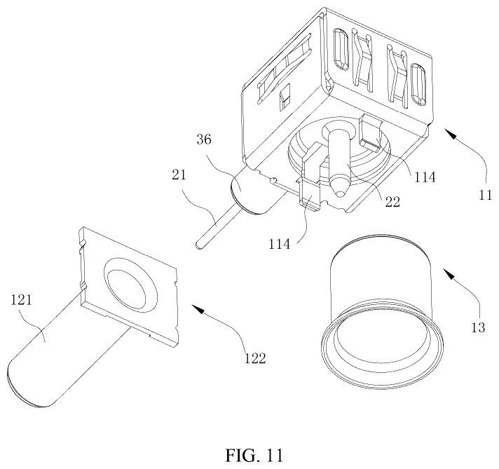

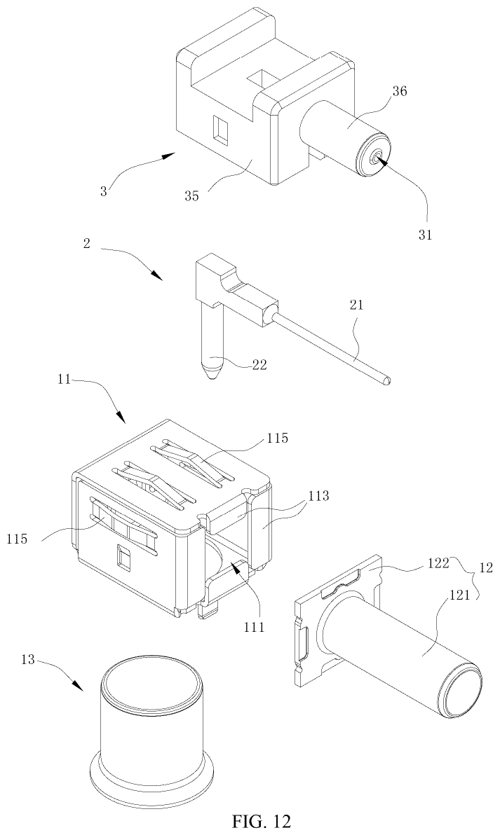

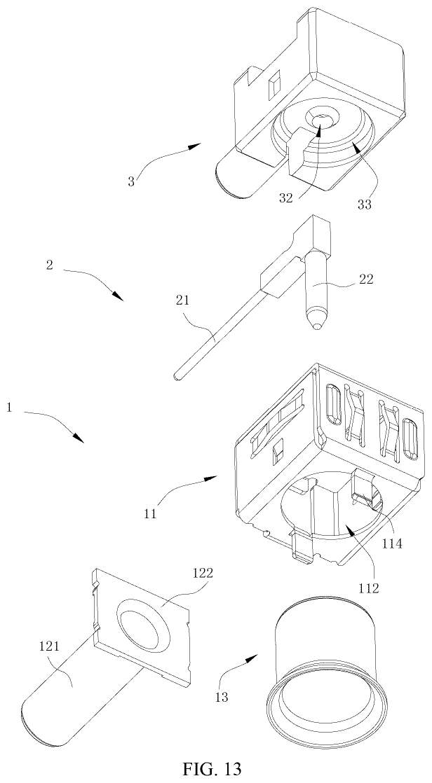

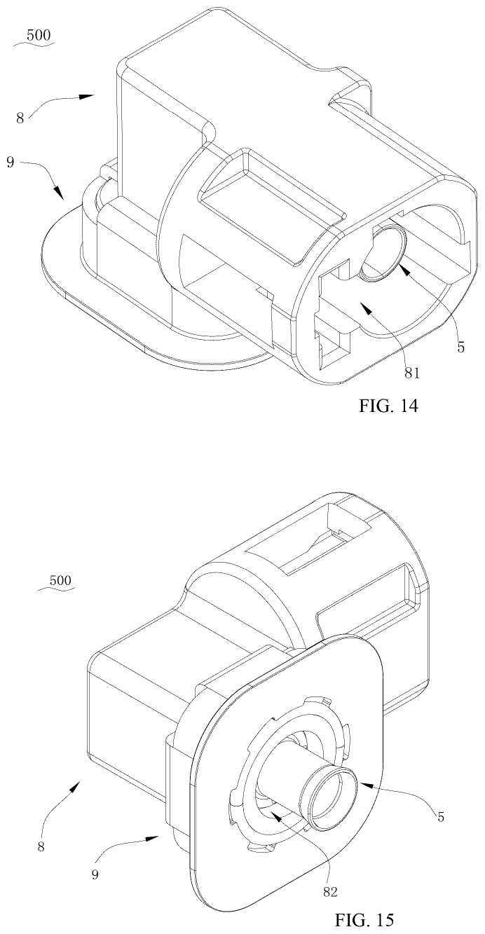

Referring to FIG. 10 to FIG. 13, the insulative housing 3 is provided therein with a horizontal passageway 31 and a vertical passageway 32 which are communicated with each other, the horizontal passageway 31 extends along a horizontal direction, the vertical passageway 32 extends along an up-down direction. Here, the first end 21 of the conductive pin 2 is provided in the horizontal passageway 31, the second end 22 of the conductive pin 2 is provided in the vertical passageway 32.

A bottom of the insulative housing 3 is recessed with an assembling cavity 33, the assembling cavity 33 faces a second opening 112 of the middle shielding shell 11. A top portion of the insulative housing 3 is provided with a recessed groove which is opened toward the up, the recessed groove is communicated with the vertical passageway 32. The design of the recessed groove realizes impedance matching of the electrical connector 100. The insulative housing 3 is insulative material, specifically, in the first embodiment, the insulative housing 3 and the conductive pin 2 are integral by insert molding.

In the first embodiment, the insulative housing 3 includes a body portion 35 and a barrel portion 36 which protrudes from one side of the body portion 35. An across section of the body portion 35 is in form of square, the barrel portion 36 is in form of barrel. The barrel portion 36 is provided to a front side of the body portion 35. The assembling cavity 33 is provided to a bottom of the body portion 35.

The conductive pin 2 is in form of L-shape, and includes the first end 21 and the second end 22 which are perpendicular to each other. In the first embodiment, the conductive pin 2 is integrally formed by stamping.

Specifically, the first end 21 and the second end 22 are perpendicular to each other. The first end 21 inserts into the horizontal passageway 31 of the insulative housing 3, the second end 22 inserts into the vertical passageway 32. And both the first end 21 and the second end 22 extend out of the insulative housing 3.

The middle shielding shell 11 is a box structure, is formed therein with a receiving cavity, most of the insulative housing 3 is received in the receiving cavity. In the first embodiment, the body portion 35 of the insulative housing 3 is positioned in the receiving cavity, the barrel portion 36 extends out of the receiving cavity, that is, the insulative housing 3 is partially received in the receiving cavity. The middle shielding shell 11 is preferably formed by bending a metal plate, when assembled, the insulative housing 3 provided with the conductive pin 2 is assembled into the receiving cavity, then the middle shielding shell 11 is bent into a box structure by bending, so that the insulative housing 3 is received in the middle shielding shell 11.

One side of the middle shielding shell 11 is provided with a first opening 111, and an edge of the first opening 111 is provided with a folding edge 113 which extends toward a center of the first opening 111, the folding edge 113 is used to connect with the first shielding shell 12. And the first opening 111 is communicated with the receiving cavity, so as to facilitate that the barrel portion 36 of the insulative housing 3 and the first end 21 of the conductive pin 2 extend out of the middle shielding shell 11. In the first embodiment, the first opening 111 is opened in a front side of the middle shielding shell 11. A profile of the first opening 111 is in form of square.

The bottom of the middle shielding shell 11 is provided with the second opening 112, the second opening 112 is used to allow an upper end of the second shielding shell 13 to pass therethrough and insert into the receiving cavity. Here, the second opening 112 is in form of circular.

The middle shielding shell 11 is provided with at least one connecting arm 114 which is positioned at an edge of the second opening 112 and extends downwardly, the connecting arm 114 elastically contacts or fixedly connects an outer surface of the second shielding shell 13, so as to make the middle shielding shell 11 and the second shielding shell 13 stably connected.

In the first embodiment, the connecting arm 114 are two in number, and the two connecting arms 114 are respectively positioned to opposite sides of the second opening 112. Elastic force generated by the two connecting arm 114 tightly clamp the second shielding shell 13, so that the second shielding shell 13 is firmly snapped below the middle shielding shell 11. In other implementing manners, the connecting arm 114 further may be one, three or more in number, the connecting arms 114 are preferably uniformly distributed circumferentially to an outer side of the second opening 112. In other some implementing manners, the second shielding shell 13 and the connecting arm 114 are connected by welding.

The first shielding shell 12 is provided to the one side of the middle shielding shell 11, and the first shielding shell 12 surrounds the outer side of the first end 21 of the conductive pin 2 to form a first mating cavity. The first mating cavity is used to allow another electrical connector to correspondingly mate therewith, and the first end 21 of the conductive pin 2 is used to electrically connect with another electrical connector which mate with the electrical connector 100.

The first shielding shell 12 includes a barrel-shaped body 121 and a connecting portion 122 which is provided to one end of barrel-shaped body 121, the connecting portion 122 is fixed on the folding edge 113. The barrel-shaped body 121 is hollow therein to form the first mating cavity.

The connecting portion 122 attaches on the folding edge 113 of the middle shielding shell 11, and the connecting portion 122 and the folding edge 113 of the middle shielding shell 11 are welded by laser, so as to realize connection between the middle shielding shell 11 and the first shielding shell 12. Specifically, an outer profile of the connecting portion 122 is in form of square, and the connecting portion 122 is outwardly beyond a circumferential edge of the barrel-shaped body 121.

The second shielding shell 13 is in form of barrel, and the upper end of the second shielding shell 13 inserts into the assembling cavity 33 and tightly fits with an inner wall of the assembling cavity 33. A bottom of the second shielding shell 13 has a guiding portion which is in form of trumpet, the guiding portion gradually expands from up to down, so as to facilitate mating of another electrical connector.

The upper end of the second shielding shell 13 extends into the assembling cavity 33 of the insulative housing 3, which is positioned in the middle shielding shell 11, via the second opening 112 of the middle shielding shell 11, and tightly fits with the inner wall of the assembling cavity 33, the second shielding shell 13 is firmly snapped below the middle shielding shell 11 together by the connecting arm 114 which is positioned at the bottom of the middle shielding shell 11.

Referring to FIG. 1 to FIG. 4, the electrical connector 100 further includes an insulative base 4 which is provided to an outer side of the shielding shell assembly 1. The insulative base 4 is provided therein with a horizontal cavity 41 and a vertical cavity 42 which are communicated with each other, the horizontal cavity 41 extends along the horizontal direction, the vertical cavity 42 extends along the up-down direction. The first shielding shell 12 extends into the horizontal cavity 41, the second shielding shell 13 extends into the vertical cavity 42.

Referring to FIG. 4 to FIG. 6, furthermore, a surface of the middle shielding shell 11 is provided with an elastic snap 115 which protrudes outwardly and a latching piece 116 which is recessed inwardly, the elastic snap 115 is used to elastically contact the insulative base 4, the insulative housing 3 and the middle shielding shell 11 may be tightly fitted therebetween by the latching piece 116.

In the electrical connector 100 of the first embodiment, the first shielding shell 12 is used to mate with an external connector along the horizontal direction, the second shielding shell 13 is used to mate with another external connector along the vertical direction, the first shielding shell 12 and the second shielding shell 13 constitute two mating cavities of the electrical connector 100 which are perpendicular to each other, thereby realizing that the electrical connector 100 mates with two electrical connectors along different directions. The electrical connector 100 of the first embodiment is lower in manufacturing cost, and is convenient in assembling.

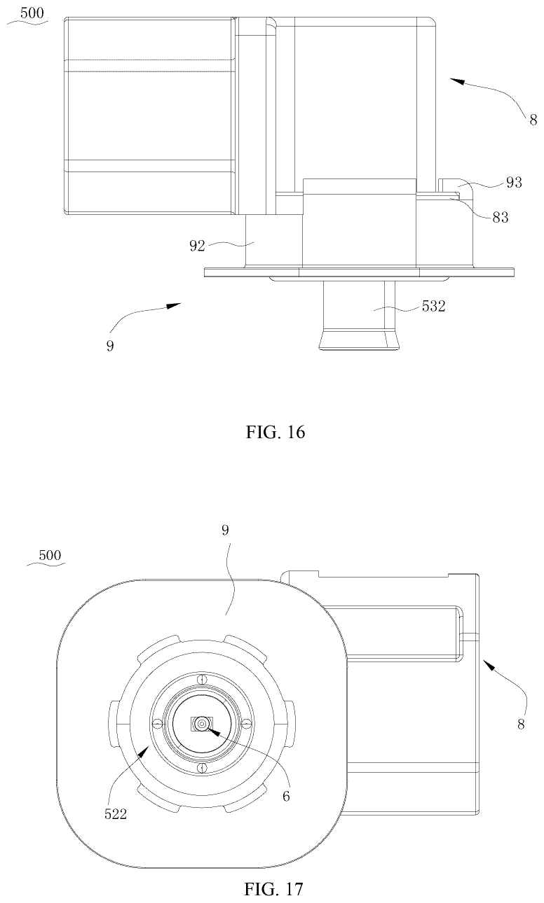

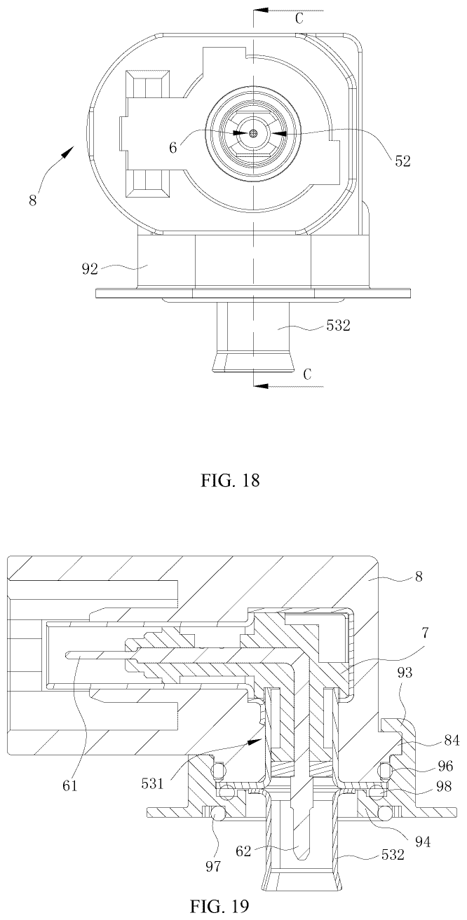

Referring to FIG. 14 to FIG. 19, an electrical connector 500 of a second embodiment similarly includes a shielding shell assembly 5, a conductive pin 6 which is positioned in the shielding shell assembly 5, and an insulative housing 7 which allows the conductive pin 6 to be fixed thereon and separates the shielding shell assembly 5 from the conductive pin 6 by a certain distance.

The second embodiment mainly differs from the first embodiment of in that, a second shielding shell 53 is different in structure, the electrical connector 500 further includes an insulative base 8 which is provided to an outer side of the shielding shell assembly 5, and a metal seat body 9 which is fixed to a bottom of the insulative base 8.

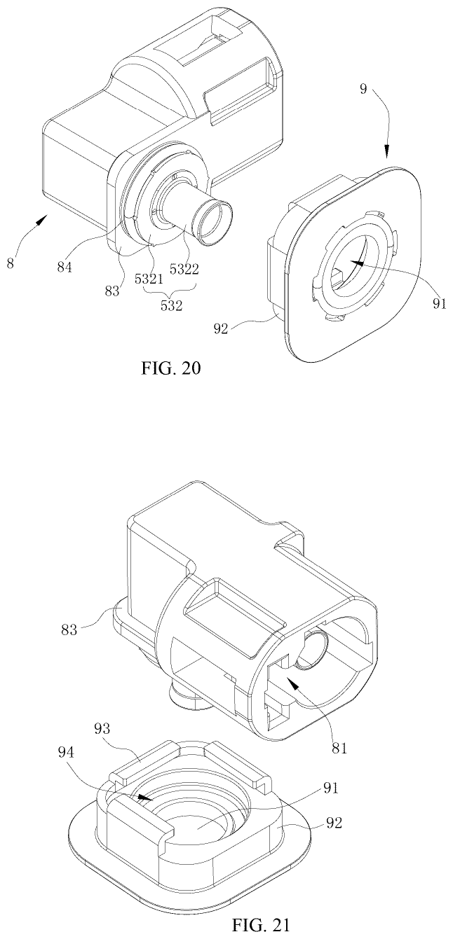

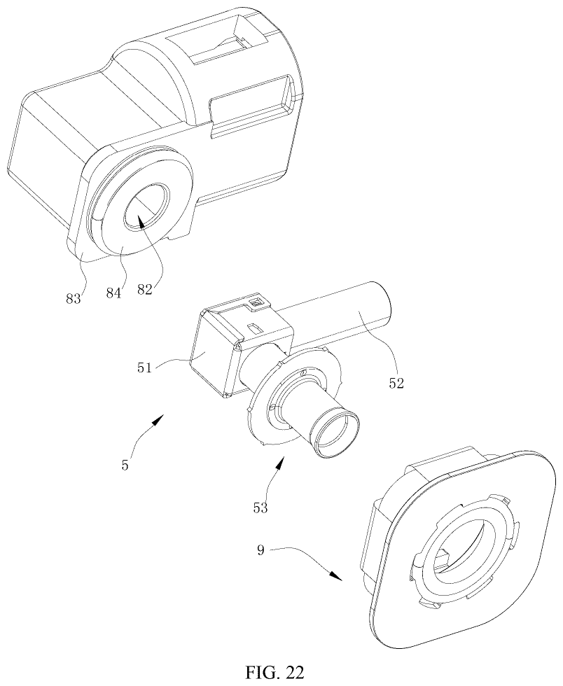

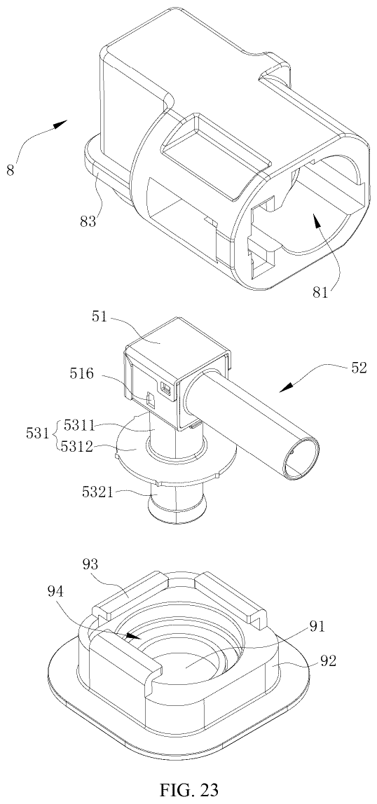

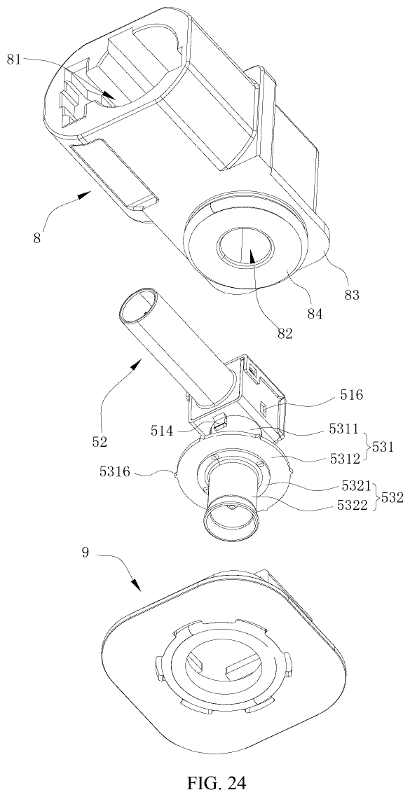

Referring to FIG. 20 to FIG. 24, the second shielding shell 53 includes an upper shell 531 and a lower shell 532. The upper shell 531 includes a first main body 5311 which is provided therein with a passageway, and a first fixing flange 5312 which is provided to a lower end of the first main body 5311 and extends horizontally. The lower shell 532 includes a second main body 5321 which is provided therein with a passageway, and a second fixing flange 5322 which is provided to an upper end of the second main body 5321 and extends horizontally, the first fixing flange 5312 and the second fixing flange 5322 attach to each other and are fixed together.

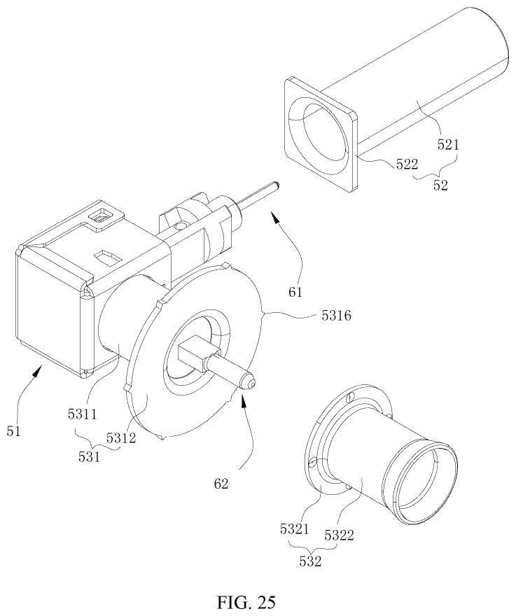

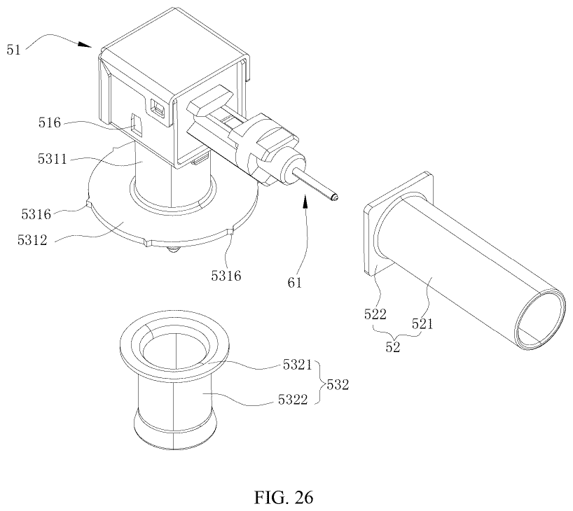

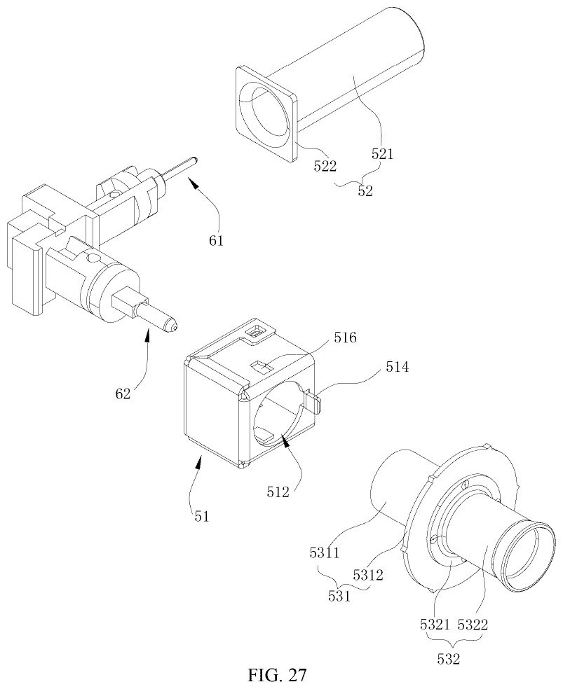

Specifically, the first main body 5311 is in form of barrel, an upper end of the first main body 5311 extends into a middle shielding shell 51. Referring to FIG. 25 to FIG. 29, an outer side of the first fixing flange 5312 is provided with a plurality of sharp protrusions 5316 which protrude outwardly, the plurality of sharp protrusions 5316 are uniformly arranged along the outer side of the first fixing flange 5312, the plurality of sharp protrusions 5316 are used to interference fit with the metal seat body 9 so as to attain good electrically connection.

The second main body 5321 also is in form of barrel, here an outer diameter of the second main body 5321 may be identical with an outer diameter of the first main body 5311, also may be not identical with the outer diameter of the first main body 5311, so that an object that another connector which has a different outer diameter mates with the second main body 5321 may be attained. Preferably, in the second embodiment, a bottom of the second main body 5321 includes a guiding portion which is in form of trumpet, the guiding portion gradually expands from up to down, so as to facilitate that the guiding portion correspondingly mates with another electrical connector (not shown). Furthermore, the outer side of the first fixing flange 5312 is outwardly beyond an outer side of the second fixing flange 5322.

The insulative base 8 is provided therein with a horizontal cavity 81 and a vertical cavity 82 which are communicated with each other, the horizontal cavity 81 extends along a horizontal direction, the vertical cavity 82 extends along an up-down direction. Here, the horizontal cavity 81 and the vertical cavity 82 are respectively used to allow a first shielding shell 52 and the second shielding shell 53 to insert therein respectively.

The insulative base 8 is an insulative material, and is used to connect with the metal seat body 9. A bottom of the insulative base 8 is provided with a protruding flange 83, and the vertical cavity 82 penetrates the protruding flange 83.

A center of the metal seat body 9 is opened with an opened hole 91 which penetrates up and down. The metal seat body 9 is provided with a mating post 92 around the opened hole 91, a top portion of the mating post 92 is provided with a plurality of folding edges 93 which bend and extend toward the opened hole 91. Specifically, in the second embodiment, an outer profile of the mating post 92 is in form of square, the folding edge 93 is three in number, the three folding edges 93 are respectively provided to a left side, a right side and a rear side of the mating post 92, and the three folding edges 93 and the mating post 92 together form a snapping space.

When the metal seat body 9 connects with the insulative base 8, a top surface of the mating post 92 abuts against the bottom of the protruding flange 83, the folding edge 93 hooks on the protruding flange 83 by stamping the folding edge 93, so as to form engagement which cannot be detached. The lower shell 532 downwardly extends out of the metal seat body 9 via the opened hole 91 of the metal seat body 9, so as to facilitate that another electrical connector mates with the lower shell 532.

Preferably, the bottom of the protruding flange 83 is provided with a mating base portion 84 which is annular, the mating post 92 sheathes an outer side of the mating base portion 84. The mating post 92 and the mating base portion 84 are provided therebetween with a first sealing ring 96 which functions to seal a gap between the insulative base 8 and the metal seat body 9 and prevent water and dust from entering into the inside of the second shielding shell 53.

A bottom of the mating post 92 is encircled with a recessed groove which is opened downwardly, the recessed groove is provided therein with a second sealing ring 97 which functions to seal between the metal seat body 9 and another electrical connector.

A lower portion of the metal seat body 9 extends inwardly and horizontally from a position at the opened hole 91 to form a step 94, the step 94 is provided to correspond to a part of the first fixing flange 5312 which is beyond the second fixing flange 5322, the step 94 and the first fixing flange 5312 are encircled therebetween with a third scaling ring 98. A sealing function of the third sealing ring 98 further increases sealing between the metal seat body 9 and the second shielding shell 53.

In the second embodiment, a first opening 511 of the middle shielding shell 51 is not provided with the folding edge 93. In the second embodiment, the first shielding shell 52 extends into the middle shielding shell 51, and an outer side of the first shielding shell 52 is connected with an inner wall of the middle shielding shell 51 by welding. A bottom of the middle shielding shell 51 is similarly opened with a second opening 512 which is in form of circular. The bottom of the middle shielding shell 51 is provided with a connecting arm 514, the connecting arm 514 is positioned at a front side of the second opening 512.

A surface of the middle shielding shell 51 is provided with a latching piece 516 which is recessed inwardly, the insulative housing 7 and the middle shielding shell 51 may realize to tight fit therebetween by the latching piece 516. Here, a left side wall and a right-side wall of the middle shielding shell 51 are provided thereon with the latching pieces 516.

In the second embodiment, the upper shell 531 of the second shielding shell 53 sheathes an outer side of a bottom of the insulative housing 7, and an outer side of the upper shell 531 is connected with a side wall of the second opening 512 of the middle shielding shell 51 by welding.

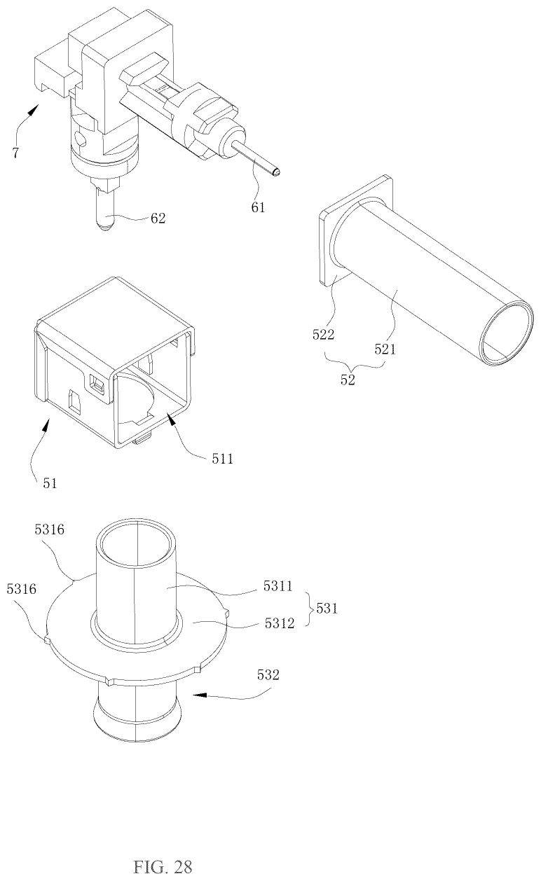

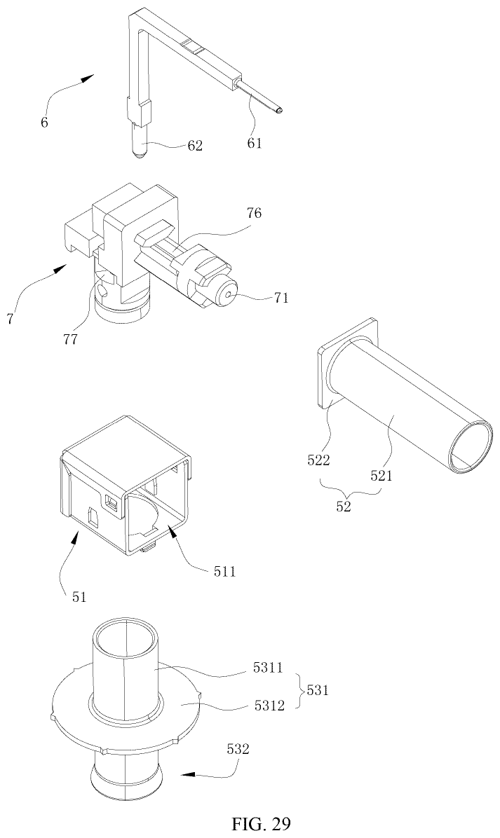

Continuously referring to FIG. 28 and FIG. 29, a top portion of the insulative housing 7 is opened with a first recessed opening 76 which corresponds to a first end 61, a side portion of the insulative housing 7 is opened with a second recessed opening 77 which corresponds to a second end 62, which may realize impedance matching of the conductive pin 6.

The electrical connector 500 of the second embodiment can similarly realize to mate with two electrical connectors along different directions. In addition, in the electrical connector 500 of the second embodiment, the second shielding shell 53 is divided into the upper shell 531 and the lower shell 532 along the up-down direction, the upper shell 531 is fixedly connected with the middle shielding shell 51, the lower shell 532 and the upper shell 531 realize mating and fixing therebetween by the first fixing flange 5312 and the second fixing flange 5322 which horizontally extend, so regardless of how a diameter and a height of the lower shell 532 is varied, the first fixing flange 5312 and the second fixing flange 5322 can smoothly match with each other and can be fixed together, so, in manufacturing, a manufacturer may only replaces the lower shell 532 based on different mating interface requirements of a client on the lower shell 532, thus variation of the remaining part is reduced as less as possible, the number of molds are reduced, manufacturing process is simplified, highly sharing an assembling manufacturing line is realized, manufacturing investment is lowered.

The other structures of the electrical connector of the second embodiment are the same as that of the first embodiment, may refer to the electrical connector of the first embodiment, so the description thereof is not repeated herein.

Although the present disclosure has been described with reference to several typical embodiments, it should be understood that the terminology used is illustrative and exemplary rather than limiting. Since the present disclosure can be embodied in various forms without departing from the spirit or essence of the present disclosure, it should be understood that the above embodiments are not limited to any of the foregoing details, but should be widely interpreted within the spirit and scope defined by the appended claims, therefore, all variations and modifications falling within the scope of the claims or equivalent ranges of the claims should be covered by the appended claims.

What is claimed is:

1. An electrical connector, comprising:
a shielding shell assembly,
a conductive pin which is positioned in the shielding shell assembly, the conductive pin comprising a first end and a second end which are perpendicular to each other, and
an insulative housing which allows the conductive pin to be fixed thereon and separates the shielding shell assembly from the conductive pin;
the shielding shell assembly comprising:
a middle shielding shell,
a first shielding shell which is provided to one side of the middle shielding shell and extends along a horizontal direction, and
a second shielding shell which is provided to a bottom of the middle shielding shell and extends downwardly,
the first shielding shell surrounding an outer side of the first end of the conductive pin to form a first mating cavity, the second shielding shell surrounding an outer side of the second end of the conductive pin to form a second mating cavity.

2. The electrical connector of claim 1, wherein
the second shielding shell comprises an upper shell which is connected with the middle shielding shell and a lower shell which is provided below the upper shell,
the upper shell comprises a first main body which is provided therein with a passageway and a first fixing flange which is provided to a lower end of the first main body and extends horizontally,
the lower shell comprises a second main body which is provided therein with a passageway and a second fixing flange which is provided to an upper end of the second main body and extends horizontally,
the first fixing flange and the second fixing flange attach to each other and are fixed together.

3. The electrical connector of claim 2, wherein
the electrical connector further comprises an insulative base which is provided to an outer side of the shielding shell assembly and a metal seat body which is fixed to a bottom of the insulative base,
the metal seat body is opened therein with an opened hole which penetrates up and down,
the lower shell downwardly extends out of the metal seat body via the opened hole.

4. The electrical connector of claim 3, wherein
the metal seat body is provided with a mating post around the opened hole,
the bottom of the insulative base is provided with a protruding flange, the protruding flange inserts into the mating post,
a top portion of the mating post is provided with a folding edge, the folding edge hooks on the protruding flange.

5. The electrical connector of claim 4, wherein
a bottom of the protruding flange is provided with a mating base portion,
the mating post sheathes an outer side of the mating base portion,
the mating post and the mating base portion are provided therebetween with a first sealing ring,
a bottom of the mating post is encircled with a recessed groove which is opened downwardly,
the recessed groove is provided therein with a second sealing ring.

6. The electrical connector of claim 3, wherein
a surface of the middle shielding shell is provided with an elastic snap which protrudes outwardly,
the elastic snap snaps with the insulative base.

7. The electrical connector of claim 1, wherein
the first shielding shell comprises a barrel-shaped body and a connecting portion which is provided to one end of the barrel-shaped body,
one side of the middle shielding shell is provided with a first opening, and an edge of the first opening is provided with a folding edge which extends toward a center of the first opening,
the connecting portion is fixed on the folding edge.

8. The electrical connector of claim 1, wherein
the bottom of the middle shielding shell is provided with a second opening,
a bottom of the insulative housing is provided with an assembling cavity which faces the second opening,
an upper end of the second shielding shell inserts into the assembling cavity and tightly fits with an inner wall of the assembling cavity.

9. The electrical connector of claim 8, wherein
the middle shielding shell is provided with at least one connecting arm which is positioned at an edge of the second opening and extends downwardly,
the connecting arm contacts an outer surface of the second shielding shell.

10. The electrical connector of claim 1, wherein
the middle shielding shell is a box structure which is formed by bending a metal plate,
the box structure is formed therein with a receiving cavity,
at least a part of the insulative housing is received in the receiving cavity.
